(19) United States
(12) Patent Application Publication
(10) Pub. No.: US 2007/0233510 A1
(43) Pub. Date: Oct. 4, 2007

(54) SERVICE TRANSACTION FACILITATION SYSTEMS AND METHODS

(76) Inventor: Paul L. Howes, Chesterfield, MO (US)

Correspondence Address: Anthony G. Fussner;Suite 400, 7700 Bonhomme, St. Louis, MO, 63105, US

(21) Appl. No.: 11/686,081

(22) Filed: Mar. 14, 2007

Related U.S. Application Data
(60) Provisional application No. 60/783,455, filed on Mar. 17, 2006.

(51) Int. Cl. G06Q 10/00

(52) U.S. Cl. 705/1

(57) ABSTRACT

Aspects of the present disclosure provide various embodiments of systems and methods that can be used for facilitating a transaction for a delivery of a service by a service provider to a service buyer. In one exemplary embodiment, a method generally includes listing a service work order in an auction for bidding by one or more service providers, and selecting a service provider from one or more service providers that submitted a bid for the service work order listed at the auction. The method can also include causing a payment from the service buyer to be escrowed, providing the selected service provider with data relating to the escrowed payment and the service buyer, and providing an escrowed payment release authorization to the service buyer. The method can further include allowing transfer of at least a portion of the escrowed payment to the selected service provider in response to receipt of the escrowed payment release authorization.

### CROSS-REFERENCE TO RELATED APPLICATION

This application claims the benefit of U.S. Provisional Application No. 60/783,455 filed Mar. 17, 2006. The disclosure of the above application is incorporated herein by reference.

### FIELD

The present disclosure generally relates to systems and methods facilitating the procurement and delivery of services and, more specifically, to systems and methods facilitating the auctioning of a request for service from a service buyer to service providers and payment by the service buyer for services performed by a selected service provider.

### BACKGROUND

The statements in this section merely provide background information related to the present disclosure and may not constitute prior art.

Service buyers seeking to purchase services from service providers frequently solicit recommendations and referrals for service providers from friends, family, and work associates. With these recommendations and referrals, the service buyers are hoping to avoid unpleasant experiences by randomly soliciting service providers from various directories. Telephone company yellow page directory advertisements/listings, telephone company business white page listings, and commercial service industry publications are sources that can be used to shop for and select a service provider.

Another possible source used by service buyers to locate and select a service provider is direct mail service promotions and solicitations. But such service provider promotional materials. But these materials are usually no more current as a source for those services than telephone directories, as such promotional materials and advertisements do not rate the recent quality of the services provided nor do they provide recent customer satisfaction feedback relating to the received services.

Yet another alternative source for consumers to seek out service providers is a local Better Business Bureau (BBB). But the local BBB relies on consumer letters or web-site input for feedback, with the input received more likely directed to complaints rather than positive endorsements for services rendered.

### SUMMARY

Aspects of the present disclosure provide various embodiments of systems and methods that can be used for facilitating a transaction for a delivery of a service by a service provider to a service buyer. In one exemplary embodiment, a method generally includes listing a service work order in an auction for bidding by one or more service providers, and selecting a service provider from one or more service providers that submitted a bid for the service work order listed at the auction. The method can also include causing a payment from the service buyer to be escrowed, providing the selected service provider with data relating to the escrowed payment and the service buyer, and providing an escrowed payment release authorization to the service buyer. The method can further include allowing transfer of at least a portion of the escrowed payment to the selected service provider in response to receipt of the escrowed payment release authorization.

According to another aspect of the present disclosure, a method for facilitating a transaction for a delivery of a service by a service provider to a service buyer generally includes hosting a first webpage configured for providing a service work order entry form for completion by a service buyer, and hosting a second webpage configured for online auctions of service work orders. The method can also include listing on the second webpage a service work order in an online auction for bidding by one or more service providers. The listing can correspond to data entered by a service buyer into a service work order entry form provided by the first webpage. The method can further include selecting a service provider from one or more service providers that submitted a bid, via the second webpage, for the service work order listed at the online auction. The method may additionally include causing a payment from the service buyer to be escrowed, electronically communicating the selected service provider with data relating to the escrowed payment and the service buyer, electronically communicating an escrowed payment release authorization to the service buyer; and electronically transferring at least a portion of the escrowed payment to the selected service provider in response to receipt of the escrowed payment release authorization.

According to yet another aspect of the present disclosure, there are provided systems that can be useful for facilitating a transaction for a delivery of a service by a service provider to a service buyer. In one exemplary embodiment, a system generally includes a network configured for transmitting electronic data. A first communication device is coupled to the network and configured for allowing a service buyer to enter data for a service work order. A second communication device is coupled to the network and configured for receiving a listing of a service work order and for placing a bid in response to the listed service work order. A server is coupled to the network. The server can be configured for receiving data relating to a service work order from the first communication device, for generating a service work order in response to the received data, for providing the listing with the service work order to the second communication device in an auction for bidding by one or more service providers, for receiving a service provider's bid from the second communication device, and for selecting a service provider from one or more service providers that submitted a bid for the service work order. The server can also be configured for transmitting to the first communication device information relating to the selected service provider and the bid associated therewith, for causing a payment from the service buyer to be escrowed, and for transmitting to the second communication device data relating to the escrowed payment and the service buyer. The server can be further configured for providing an escrowed payment release authorization to the service buyer, and for allowing transfer of at least a portion of the escrowed payment to the selected service provider in response to receipt of the escrowed payment release authorization.

According to a further aspect of the present disclosure, there are provided methods relating to selection of a service provider for maintenance services to be performed on a motor vehicle having an onboard computer. In one exemplary embodiment, a method generally includes providing a predetermined work order form for use by the motor vehicle's onboard computer to be automatically transmitted therefrom without manual intervention by the service buyer when the onboard computer has determined that the motor vehicle needs a maintenance service. The predetermined work order form may include information identifying the service buyer, information identifying the motor vehicle type, and/or a description of the maintenance service to be performed on the motor vehicle. The method may also include receiving the predetermined work order form automatically transmitted by the motor vehicle's onboard computer, and then providing the predetermined work order form to one or more potential service providers.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram representation of a buyer service transaction facilitation system according to one exemplary embodiment of the present disclosure.

FIG. 2 is a block diagram representation of a computer-implemented buyer service transaction facilitating/coordinating system according to one exemplary embodiment of the present disclosure.

FIG. 3 is a process flow chart of a method for facilitating a service transaction between a service buyer and a service provider according to one exemplary embodiment of the present disclosure.

FIG. 4 is a process flow chart of another method for facilitating a service transaction between a service buyer and a service provider according to another exemplary embodiment of the present disclosure.

FIG. 5 is a block diagram representation of a computer system configured for implementing a service transaction facilitating/coordinating system or method according to one or more embodiments of the present disclosure.

FIG. 6 is a process flow chart of a method relating to selection of a service provider for maintenance services to be performed on a motor vehicle having an onboard computer according to various embodiments of the present disclosure.

FIG. 7 is a process flow chart of an exemplary dispute resolution process that may be used in any one or more of the various embodiments of the present disclosure.

### DETAILED DESCRIPTION

The following description is merely exemplary in nature and is in no way intended to limit the present disclosure, the disclosed applications or uses. It should be understood that throughout the drawings, corresponding reference numerals indicate like or corresponding parts and features.

The inventor hereof has recognized that what buyers desire is a trusted concierge-like service that facilitates connecting buyers with service providers, that includes recent customer feedback and service quality ratings for service providers, that provides a competitive auction-like procurement venue and/or that facilitates payments for services rendered. Accordingly, the inventor hereof has succeeded at designing systems and methods that are capable of facilitating a competitive service procurement process between service buyers and service providers. In various embodiments, the systems and methods disclosed can generally include receiving a service work order from a service buyer, listing the service work order in an auction-like venue for bidding by one or more service providers, providing customer satisfaction and service-provider quality-of-service (QoS) data to buyers for service providers submitting bids to assist buyers in assessing received bids and facilitating financial payment transactions between service buyers and service providers.

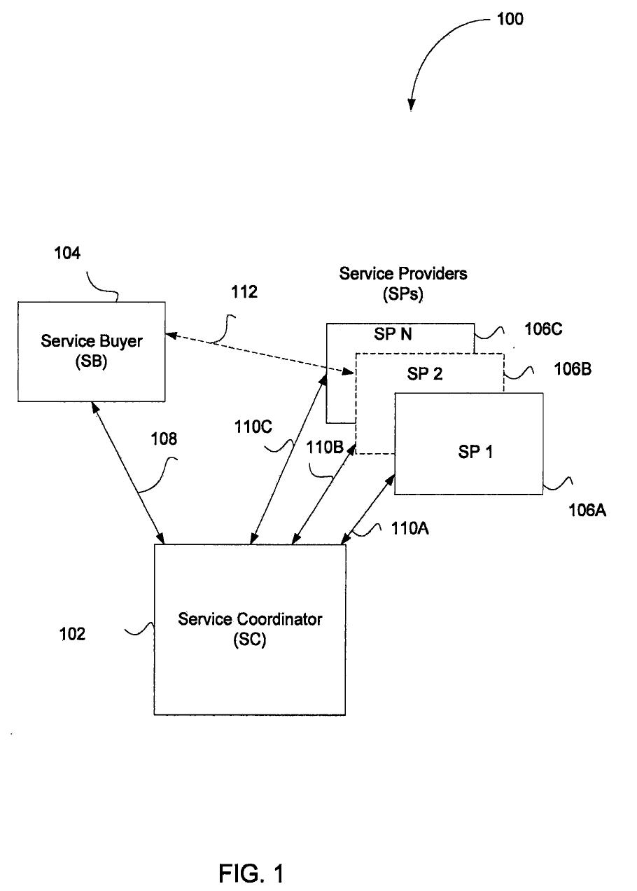

FIG. 1 illustrates a system 100 embodying one or more aspects of the present disclosure. As shown, the system 100 includes a service facilitator or coordinator 102 that coordinates the procurement and providing of services between a buyer of a service (e.g., service buyer 104) and one or more service providers 106A, 106B, and 106C that are willing to provide the service to the service buyer 104. In the illustrated system 100, direct communications 112 are not provided between the service buyer 104 and each candidate service provider 106 during the service provider auction process. Alternatively, other embodiments may include at least some communications (e.g., transfer of digital pictures, etc.) being allowed between the service buyer 104 and a service provider 106 during the service provider auction process.

With continued reference to the illustrated embodiment of FIG. 1, the service buyer 104 submits a service work order 108 to the service facilitator 102 for presenting to service providers 106 that may want to submit a bid for the requested service. Communications between a service buyer 104 can be via a communication facility (not shown) or otherwise. Communications between each service provider 106 and the service coordinator 102 can be via links 110A, 110B, and 110C.

In the illustrated system 100, each service provider 106 may be provided with little to no knowledge regarding the other competing service providers 106. In various embodiments, each service provider 106 may not have knowledge of the specific low bids submitted by all other service providers 106. But the current lowest bid may be available to the service providers 106 in order to allow the service providers 106 to assess whether to submit a revised lower bid. This can be implemented as a reverse arrangement.

Each service provider 106 can also be registered with the service coordinator 102 if the service provider 106 meets registration qualification standards. In order to be registered, for example, a service provider 106 may have to meet certain professional licensing requirements for the services rendered, meet any employee bonding requirements, identify services offered, reside within a certain geographic service area (e.g., determined by zip code and/or area code, etc.), and/or provide a description of qualifications for providing offered services. The service coordinator system of FIG. 1 can be viewed as a service buyer request-for-quote (RFQ) process, wherein the service buyer 104 and competing service providers 106 are unknown to each other upon initiation of the competitive procurement process managed by the service coordinator 102. The successful bidder (e.g., the service provider 106 selected by the service coordinator 102 as submitting the lowest bid by the service coordinator 102 from the bid submissions) may be the only service provider 106 that receives information related to the service buyer 104 from the service coordinator 102. At that time, communications link 112 between successful bidder 106B and service buyer 104 (illustrated as a dashed link and thus not enabled) may become a closed communications link. In such exemplary embodiments then, the service coordinator process may maintain service buyer data as confidential information throughout the competitive bidding process and is only shared with the successful service provider bidder.

The communications links 108, 110A-C, and 112 of FIG. 1 can be voice telecommunications, registered mail, emails, communications between personal digital assistants (PDAs) and/or other handheld portable communication devices, land-line communications, combinations thereof, etc. In some embodiments, the communications links allow only communications that are secure and maintain the confidentiality of the service buyer's information.

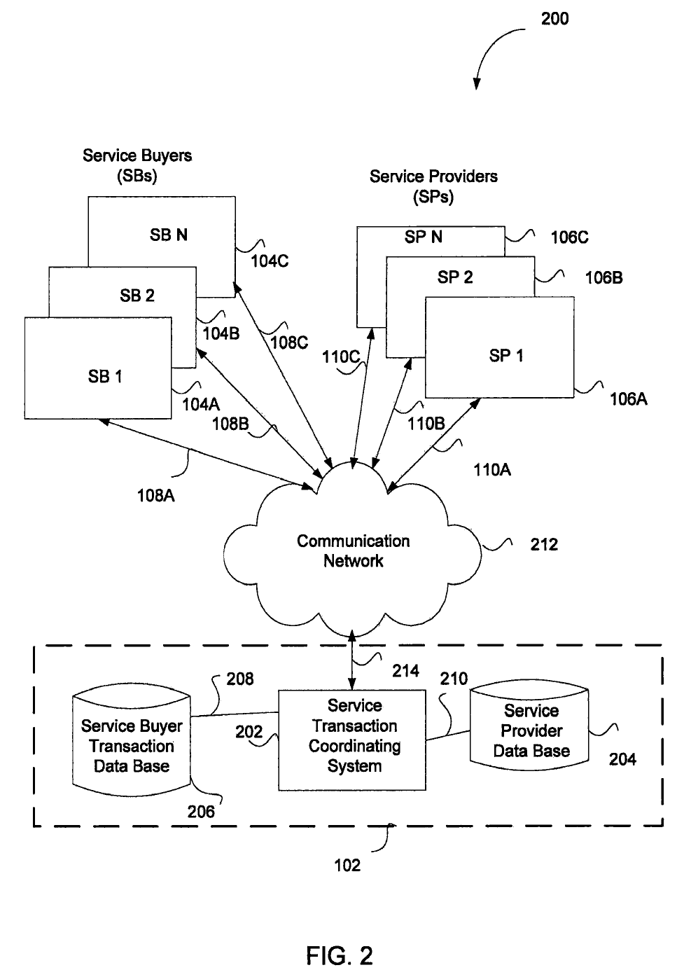

FIG. 2 illustrates a computer-implemented service transaction facilitating/coordinating system 200 according to one exemplary embodiment of the present disclosure. In this illustrated embodiment, the service coordinator 102 is shown to include a server 202 that interfaces to a service buyer transaction data base 206 and a service provider data base 204. Communications links 208 and 210 between the server 202 and data bases 206 and 204, respectively, can be carrier leased lines, private network links or standard local area network communications such as 802.3, 802.11a/b/c or 802.16, by way of example. Other communications technologies may also be used in other embodiments and the exemplary technologies are not intended to limit the scope of communications technologies used in an embodiment. The service buyer transaction and service provider data bases can be separately maintained to help ensure the confidentiality of service buyer 104 and service provider information.

As shown in FIG. 2, a communication network 212 interconnects service buyers 104 and service providers 106 to the service coordinator 102 via a plurality of communications links 214, 108A-C, and 110A-C, by way of example. In this illustration, multiple buyers 104 can submit individual service buyer work orders to the service coordinator 102 for listing in a competitive procurement bidding process. The service coordinator 102 functions as an intermediary gateway for such communications. The service providers 106 may be kept unaware of the service buyer 104 until that service buyer's work order request 108 is listed or posted by the service coordinator 102 in the transaction data base 206.

As each service buyer work order request 108 is received by the service coordinator 102, the service request 108 can be posted on a service request list. The service buyers 104 can submit their service requests to the service coordinator, by way of example, from a computer terminal, a personal digital assist (PDA), cellular telephone, a voice call to a service bureau or server of the service coordinator 102, combinations thereof, etc.

The service providers 106A-C can access the service request lists hosted on the service coordinator server 202 via data communications access links 106A-C. By way of example, data communications access links 106 may include dial-up modem telephone lines, dedicated private network lines, leased carrier lines, internet access lines, combinations thereof, etc. Communications between service buyers 104 and service providers 106 are preferably maintained on a confidential basis by the service coordinator 102 until the service coordinator 102 has received its service provider bid submissions and selected the lowest bidding service provider 106. Subsequent to service buyer confirmation of the service coordinator selected service provider 106, the service coordinator 102 preferably provides buyer data only to the successful service provider bidder.

In one embodiment of the present disclosure, a method for facilitating a transaction for a delivery of a service by a service provider 106 to a service buyer 104 includes receiving a service work order from the service buyer 104, listing the service work order in an auction for bidding by one or more service providers 106, receiving a bid from at least one of the one or more service providers 106 in response to the listing, selecting one of the at least one of the one or more service providers 106 in response to the receiving the bid, receiving a payment in escrow from the service buyer 104, the payment being in response to the received bid associated from the selected service provider 106, providing the selected service provider with a notification of the escrowed payment and data about the service buyer 104, providing a payment release authorization to the service buyer 104 in response to receiving the payment in escrow, receiving the payment release authorization, and transferring at least a portion of the escrowed payment to the selected service provider 106 in response to receiving the payment release authorization.

In some embodiments, the service coordinator 102 may receive a collection fee from a service provider 106 (or the service buyer 104 in other embodiments), where that fee is collected after the payment has been escrowed. The collection fee may be a fixed percentage of the total escrowed payment. Or, for example, the collection fee may comprise a variable percentage that decreases as the escrowed payment increases (e.g., 5% for first $10,0000 of escrowed payment, 4% of the next $10,000, etc.). As yet another example, the collection fee may be a fixed dollar amount that is not a percentage of the total escrowed payment. In some embodiments, the collection fee may be taken directly from the escrowed payment. Alternatively, other embodiments may require the service provider 106 or service buyer 104 to pay the collection fee separately from the escrowed payment.

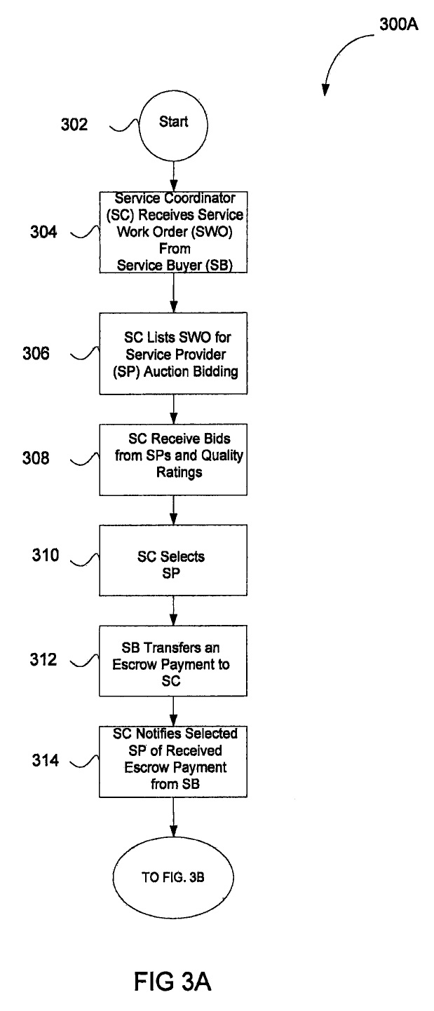

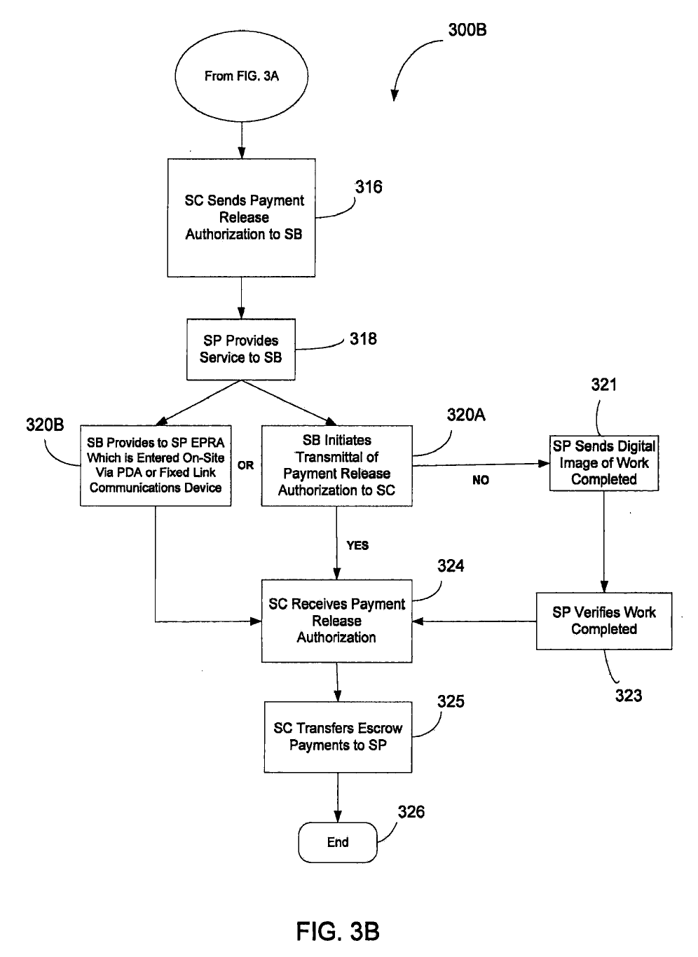

FIG. 3 illustrates an exemplary method 300 that can be implemented by service coordinator 102, such as system 200 of FIG. 2. As shown in FIG. 3, the method generally begins at process 302. At process 304, the service coordinator 102 receives a service work order 108 from a service buyer 104. At process 306, the service coordinator 102 lists or posts the service work order 108 on a presented bid list that can be received by one or more service providers 106. The receipt or access to the service work order 108 by any of the service providers 106 may be in response to the service provider 106 registering, a characteristic of the service provider 106, and/or a characteristic of the service work order 108. The service coordinator 102 receives individual bid submissions from one or more service providers 106 in process 308. The service coordinator 102 selects one or more of the service providers 106 from among those having submitted a bid at process 310. This selection can be based on the service provider 106 that submitted the lowest bid from the received bid submissions. In other embodiments, the selection can additionally or alternatively be based on other selection criteria as designated by the service buyer 104 in the service work order 108, as designated by the service coordinator 102, combinations thereof, etc.

A service provider 106 can be included within the service provider data base 204 and/or can receive one or more service work orders 108 for bidding after properly submitting qualifying service provider information to the service coordinator 102. Subsequent to review and approval by the service coordinator 102, a service provider profile can be created for each service provider 106 within the service provider data base 204. By way of example only, a service provider profile can include verification of licensing qualifications of the service provider 106, verification of professional certifications, verification of provided workers compensation, hours of operation, premium hours of operation, geographic areas served (e.g., zip codes, area codes, etc.), employee security bonding, quality ratings, combinations thereof, etc. Each service provider bid submission can be screened by the service coordinator 102 against the service provider data base of registered service providers 106. If the service provider 106 is registered and meets the predefined qualification criteria (e.g., provided by the service buyer 104, the service coordinator 102, etc.), the bid may then be accepted. By way of example, the predefined qualification criteria can include a minimum service quality rating, a service provider service location preference, service license certification, trade union membership, combinations thereof, etc. If the selected criteria are not met, the bid submission is not accepted by the service coordinator 102.

Other information that can be included within the service provider data base may include quality ratings for each service offered by the service provider 106 and/or customer feedback evaluations, for example. This information can be accessed by the service buyer 104 as additional information to consider in evaluating and selecting a service provider 106.

After the service buyer 104 accepts the service coordinator-selected service provider 106, the service buyer 104 is provided with the amount of the winning bid and can transfer a payment for escrow at process 312. This payment may be transferred directly to the service coordinator 102 for placement in escrow or trust by the service coordinator 102. Alternatively, the service coordinator 102 may instead provide information to the service buyer 104 for transferring the payment directly to an escrowee third party. In either case, the service coordinator 102 can then notify the selected service provider 106 of the escrowed payment at process 314. At process 316, the service coordinator 102 issues an escrowed payment release authorization (EPRA) code (or other authorization means as described herein) to the service buyer 104.

At process 318, the service provider 106 provides the requested service to the service buyer 104. Assuming the service buyer 104 is satisfied with the service provided by the service provider 106, the service buyer 104 can initiate a transmittal of an escrowed payment release authorization (EPRA) to the service coordinator 102 using the received authorization code at process 320A. Alternatively, the service buyer 104 may instead provide an escrowed payment release authorization (EPRA) to the service provider 106 at process 320B. The EPRA may, for example, be entered by the service buyer 104 onsite via a PDA, another other suitable handheld portable communication device, a fixed or land line based communication device, etc. The service provider 106 may then, in turn, submit the escrowed payment release authorization to the service coordinator 102.

In some situations, the service buyer 104 may fail to initiate the transmittal of the escrowed payment release authorization (EPRA), for example, if the service buyer 104 is not satisfied with the service provided by the service provider 106, etc.). In which case, the service provider 106 may then send information to the service coordinator 102 at process 321. That information may include digital photographs or other evidence showing that the work has been completed. At process 323, the service coordinator 102 may then review that information and verify whether the work has been completed. If so, the service coordinator 102 may then take the appropriate actions (e.g., contacting the service buyer 104, etc.) so that the service coordinator 102 will receive the payment release authorization at process 324. Alternative embodiments may include the service coordinator 102 (after determining at process 323 that the work has been completed) skipping process 324 entirely and moving directly to process 325 at which the service coordinator 102 transfers the payment held in escrow to the service provider 106.

When the service coordinator 102 receives the payment release authorization at process 324, the service coordinator 102 then transfers the payment held in escrow to the service provider 106 at process 325, thereby completing the transaction at process 326. The transfer of the escrowed payment at operation 325 can be accomplished in a number of ways. By way of example, the transfer may include electronically transferring the escrowed payment to an account of the service provider 106 and/or electronically issuing a credit to an account of the service provider 106. In alternative embodiments, the transfer may include issuing a payment (e.g., cash, paper check, etc.) to the service provider 106. In yet other embodiments, the service coordinator 102 may simply allow or cause the transfer rather than actually transferring the escrowed payment itself. In such embodiments, the service coordinator 102 may, for example, issue instructions to the escrowee third party to transfer the escrowed payment to the service provider 106. In response to the instructions from the service coordinator 102, the escrowee third party may then electronically transfer the escrowed payment to an account of the service provider 106, electronically issue a credit to an account of the service provider 106. In alternative embodiments, the escrowee third party may instead issue a payment (e.g., cash, paper check, etc.) to the service provider 106.

By way of example, the payment release authorization may be any suitable authorization, such as an alphanumeric code, a numeric code, an alphabetic code, a voice authorization code, a barcode, a password, a voice recognition authentication, a password, a fingerprint authorization, combinations thereof, among other suitable security validation techniques/technologies. The service buyer 104 can provide the payment release authorization either directly or indirectly to release escrowed payments to the service provider 106 or an account of the service provider 106. Alternatively, the service buyer 104 may provide the code to the service provider 106 upon service buyer satisfaction with the completed service, thereby enabling the service provider 106 to initiate release of the escrowed payment funds. For work orders encompassing multiple services from a single service provider 106 (e.g., carpentry work, drywall work, drywall painting, etc.), multiple authorization codes may be issued to release escrowed payments as a series of payments from an escrow fund upon satisfactory completion of each service.

In some embodiments, a service provider 106 may be required to register with the service coordinator 102 before the service provider 106 is allowed to participate and submit a bid in an auction. This registration can include, in some cases, the payment of a registration fee. In such cases, preferably only those bids submitted by registered service providers 106 are considered by the service coordinator 102. In some embodiments, this can include validating the receiving registration against predefined validation criteria. By way of example only, the predefined validation criteria can include criteria such as verification of a security bond, verification of adequate workers compensation, verification of licensing or certification associated with particular service(s) to be provided by the service providers 106, combinations thereof, etc. Additionally, or alternatively, the registration can include identification of one or more listings of services provided by the service provider 106, identification of geographic areas in which the service provider 106 offers a service, a description of a qualification of the service provider 106 to provide a particular service, combinations thereof, etc.

In some embodiments, the service provider 106 can submit a question to the service coordinator 102 to further clarify service work order requirements. After receipt of the question from the service provider 106, the service coordinator 102 can transmit (e.g., via email, etc.) the question to the service buyer 104. The service coordinator 102 may receive a response from the service buyer 104 (e.g., via reply email, etc.) and then post the question and answer thereto in the listing information of the service work order data.

The service coordinator 102 can also provide a service work order entry form to the service buyer 104. In such exemplary embodiments, the form may include standard checkbox-like selections associated with a service and a provision for the description of non-standard requirements. The posted or listed service work order can then describe the service to be performed, where that description corresponds with the data input or entered by the service buyer 104 into the service work order entry form. Additional form fields may be provided in some embodiments to facilitate the entry of additional requirements by the service buyer 104. In some embodiments, the service work order entry form may be provided or transmitted to the service buyer 104 as a digital image.

In other exemplary embodiments, a method can also include receiving a request by a service buyer for third-party financing of at least a portion of the dollar amount of the accepted bid of the selected service provider 106. That request can then be forwarded by the service coordinator 102 to one or more financing parties. In such embodiments, at least a portion of the funds comprising the escrowed payment may be provided by a financing party.

In other exemplary embodiments, a service work order may include a schedule for a plurality of payments associated with one or more discrete deliverables or services to be performed. In such embodiments, payment release authorizations may be transmitted to the service buyer 104 in response to the payment schedule.

In further exemplary embodiments, a service buyer 104 may submit a work order change request to the selected service provider 106. Or, for example, the service provider 106 may also or alternatively submit a work order change request. By way of example, a service buyer 104 may submit a work order change request that includes a supplemental escrowed payment associated with the incremental cost of the work order change request. The work order change request may, for example, be provided as a digital image. In an alternative embodiment, the work order change request may be initiated by the selected service provider 106 (along with the incremental costs for such change), with the work order change request then being transmitted to the service buyer 104 for approval. Subsequent to service buyer approval of the requested work order change, the service buyer 104 may then submit a supplemental escrowed payment for the work order change. The service coordinator 102 may then send a payment release authorization code for the escrowed supplemental payment. Alternatively, the escrowed supplemental payment may instead be associated with the payment release authorization provided for the original escrowed amount. One example where such service provider initiated work order change can be required may occur when the requested service, as stated in the work order, does not meet local code standards for the requested service.

It is anticipated that aspects of the present disclosure will be used with a wide range of services, and aspects of the present disclosure are not limited to any particular or specific service. By way of example only, service work orders can include services relating to building construction services, such as remodeling existing structures, constructing a building addition and constructing a new building. By way of further example, service work orders can also include services relating to automotive services, plumbing services, flooring services, professional services, HVAC services, roofing services, electrical services, garage door services, glass installation/repair services, computer services, appliance services, cleaning services, and/or any other business or service associated with or assigned a Standard Industrial Classification (SIC) code, etc. As other example, aspects of the present disclosure may be used in connection with medical industry, such as surgery (e.g., cosmetic surgery, breast implants, laser vision correction surgery, etc.). In the medical industry, the insurance provider (e.g., Medicare, Blue Cross/Blue Shield, etc.) may be considered as the service buyer, and the hospital, doctor's office, etc. may be considered as the service provider.

In various exemplary embodiments, a method can include receiving automated data communications from a mobile platform, such as automobile, bus, truck, motorcycle, boat, airplane, rotorcraft, watercraft, snowmobile, jet ski wave runner, bicycle, scooter, farm equipment, etc. Other exemplary embodiments may include receiving automated data communications from a stationary platform, such as an intelligent in-home appliance (e.g., refrigerator, air conditioner, heater, etc.), etc. where the stationary platform or appliance has an onboard computer capable of generating the automated data communication, such as a request for service. For example, a data communication may be submitted automatically after being computer-generated from a computer onboard an automobile. The automated data communications can include data identifying the service buyer 104, the type of mobile platform to be serviced, and the service work order including a description of the service to be performed (e.g., a maintenance service, such as tire rotation or oil change for an automobile, etc.). The automatically communicated service work order can be automatically posted on the service provider bid list and/or transmitted to a plurality of service providers 106 qualified to perform the requested service. The received bid submissions can then be transmitted to the service buyer 104 for service provider selection. In some embodiments, a service provider may be allowed to provide a calendar or list of one or more available appointment dates for selection by the service buyer 104.

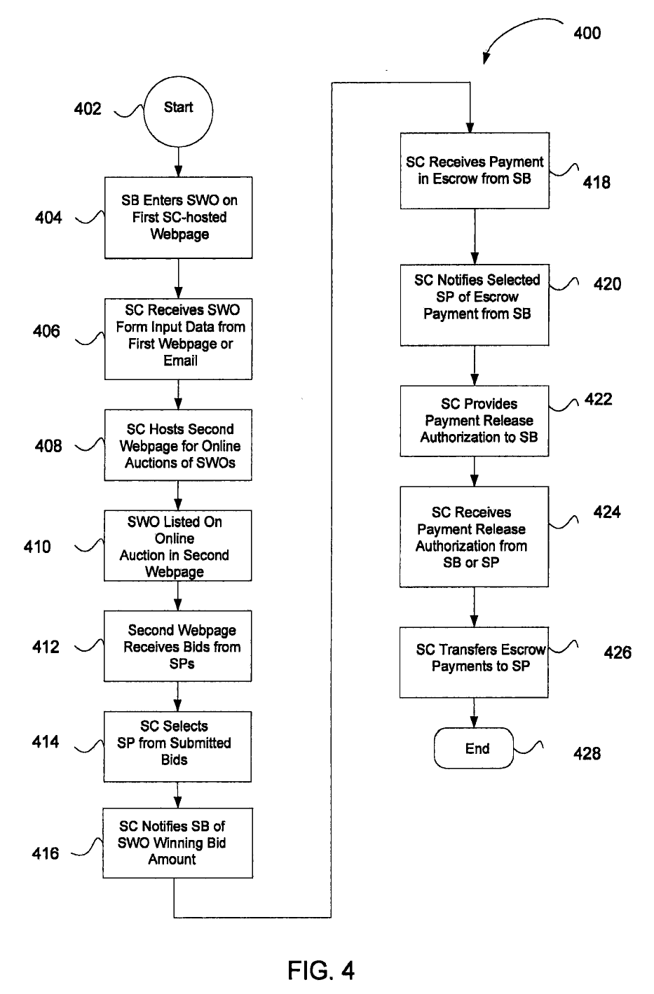

FIG. 4 illustrates an alternative computer-implemented method 400 for facilitating a transaction for a delivery of a service by a service provider 106 to a service buyer 104. As shown in FIG. 4, the method 400 generally begins at process 402. At process 404, the service buyer (SB) 104 enters information and data relating to a service work order (SWO) through data entry into fields of a first service coordinator-hosted webpage. The first hosted webpage can include a form that has drop-down menu selection choices for requested service categories and/or free-form input field entries for service buyer input of non-standard information. For example, automotive maintenance service drop-down menus can include choices for oil changes, transmission fluid services, engine tune-ups, battery replacement, tire rotation, etc. By way of further example, non-standard entries for automotive services may include requests for exterior body repair, hub cap replacement, parts orders, paint touch-up body work, etc.

In process 406, the service coordinator (SC) 102 receives the data relating to the service work order entered in the form by the service buyer 104 via the first webpage or email. The service coordinator 102 can also host a second webpage for online auction presentation of submitted service work orders in process 408. In process 410, the submitted service work order is presented or listed in an online auction on the second webpage. The second hosted webpage can be an auction webpage that is service category specific, for example, an auction-like bidding page that only presents requested automotive maintenance service work order requests. Service providers 106 can access the second webpage.

The service coordinator 102 can receive bids from the service providers 106 in process 412. After receiving submitted bids, process 414 includes the service coordinator 102 selecting the service provider 106 that submitted the lowest bid. In some embodiments, each service provider 106 can be given the opportunity to review the history of submitted bids on the service coordinator-hosted second webpage. Preferably, the page does not disclose identity data for each service provider 106, but only discloses the bid amount of each bid in the submitted bidding history.

In one embodiment, the service coordinator 102 can notify the service buyer 104 of the winning bid (e.g., the lowest bid) at process 416 and, if acceptable to the service buyer 104, the service buyer 104 submits payment to be escrowed. The service coordinator 102 can receive and escrow the payment from the service buyer 104 at process 418. The service coordinator 102 notifies the winning service provider 106 of the escrowed payment at process 420. The service coordinator 102 provides the service buyer 104 with a payment release authorization at process 422.

At process 424, the service coordinator 102 receives a payment release authorization from either the service buyer 104 or service provider 106, depending on the particular embodiment. For some services, the escrowed amount may cover the initial cost of materials and a nominal percentage of the associated labor costs, for example. Upon receipt of the payment release authorization, the escrowed payment (or portion thereof) may then be released to the service provider 106 at process 426, thus completing the method in process 428.

In an alternative embodiment, the service buyer 104 may desire to receive a plurality of low bids or a minimum number of bids. The bids may be ranked by lowest bid submission with associated service quality ratings for each service provider 106 for each included service category of the bid submission. Various embodiments can also include customer testimonial data as part of the service provider data base information provided to a service buyer 104. In such embodiments, the service buyer 104 evaluates the service coordinator-provided bidding data and transmits his selected service provider 106 decision to the service coordinator 102 along with the payment to be escrowed to the service coordinator 102 at process 420.

In various embodiments, the competitive bidding process comprises a “blind” bidding process to the service buyer 104 until the service coordinator 102 provides the service buyer 104 the winning low bid (or desired plurality of lows bids) from the service coordinator-managed auction process. In such embodiments, the service buyer 104 preferably does not have access to the second webpage (the active bidding webpage) and the service providers 106 do not have access to the service buyer first webpage (the work order submission webpage).

Service work orders utilized within the disclosed methods and systems can include one or more of a plurality of defined service categories. In such embodiments, listing service work orders can include categorizations of the service work orders. Service work orders can include minimum service provider quality ratings, such that selecting a service provider is based at least partially on minimum service provider quality ratings. In such embodiments, the service coordinator 102 may be configured to only accept bids from those service providers meeting the minimum service provider quality rating criteria.

Service quality ratings may be maintained in the service provider data base 204 by the service coordinator 102 from feedback received from service buyers 104 that have received a service from a service provider 106. The service coordinator 102 can generate a rating for a service provider 106 based at least partially on this feedback from the service buyer 104. The selection of a service provider 106 by a service buyer 104 may then be based at least partially on the service provider rating generated by the service coordinator 102.

In some embodiments, a service work order can include a plurality of sub-service work orders 108, each of which is associated with a different type of service work to be performed by a service provider 106. In such embodiments, the listing of the various sub-service work orders, along with receiving of bids, and the selection of sub-service providers 106 and the other processes can be repeated for each sub-service work order. For example, the service buyer 104 may desire to have a custom home. In this particular example, the service buyer 104 can download a housing design or print to the service coordinator 102 and identify one or more of a variety of contractor or sub-service work orders 108 for completely building the custom home. The service coordinator 102 can list and/or auction off each of the sub-service work orders 108 that collectively will result in the custom home being built as requested by the service buyer. Other examples (while not separately identified herein) that require multiple sub-service work orders 108 are also considered to be within the scope of the present disclosure. This can include complex installations, installation or maintenance at a plurality of locations, by way of example.

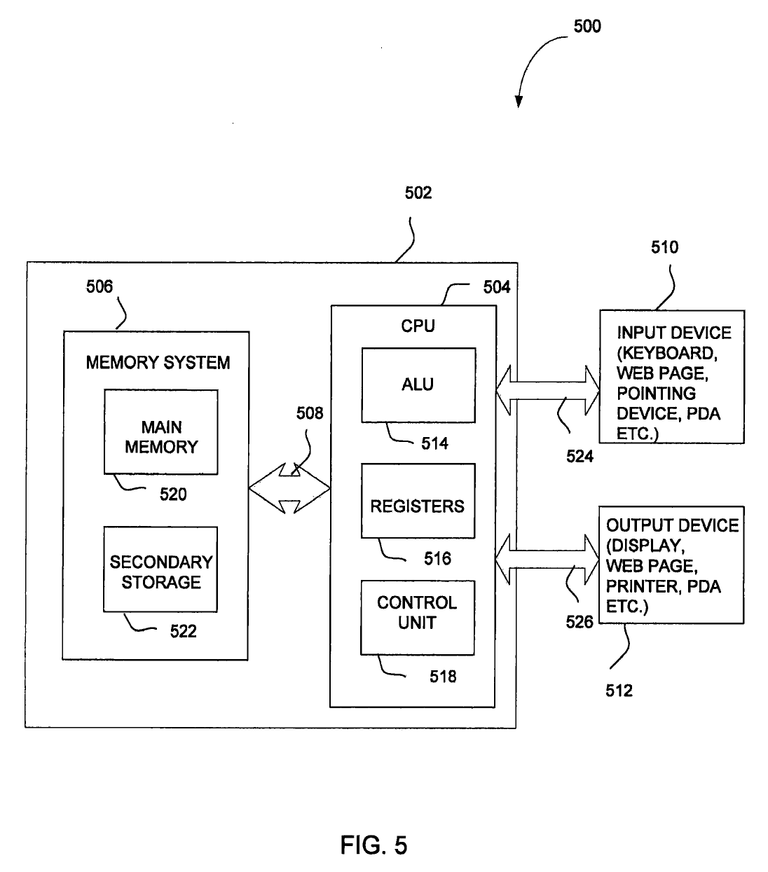

FIG. 5 illustrates an exemplary computer operating environment that may be used for implementing a service transaction facilitating/coordinating method according to an exemplary embodiment of the present disclosure. As shown in FIG. 5, the illustrated operating environment generally includes a computer system 500 with a computer 502. The computer 502 comprises at least one central processing unit (CPU) 504, a memory system 506, and at least one bus structure 508 interconnecting the CPU 504 and memory system 506. An input device 510 and an output device 512 are also shown interconnected to the computer 502 respectively via interfaces 524 and 526.

With continued reference to FIG. 5, the illustrated CPU 504 includes an arithmetic logic unit (ALU) 514 for performing computations, a collection of registers 516 for temporary storage of data and instructions, and a control unit 518 for controlling operation of the system 500. Any of a wide variety of processors can be used such as one or more processors from Digital Equipment, Sun, MIPS, Motorola, NEC, Intel, Cyrix, AMD, HP, and Nexgen, is equally preferred for the CPU 504. The illustrated embodiment of the present disclosure operates on an operating system designed to be portable to any of these processing platforms.

The illustrated memory system 506 generally includes high-speed main memory 520, which may be in the form of one or more media such as random access memory (RAM) and/or read only memory (ROM) semiconductor devices. The illustrated memory system 506 is also shown with secondary storage 522, which may be in the form of long term storage mediums such as floppy disks, hard disks, tape, CD-ROM, flash memory, combinations thereof, among other devices that store data using electrical, magnetic, optical, and/or other recording media. The main memory 520 can also include video display memory for displaying images through a display device. The memory system 506 can comprise a variety of alternative components having a variety of storage capacities.

The input device 510 and output device 512 can also include a wide range of devices. By way of example, the input device 510 may include a keyboard, a mouse, a physical transducer (e.g. a microphone, etc.), a personal digital assistant (PDA) and/or other handheld portable communication device, a combination thereof, etc. The input device 510 is interconnected to the computer 502 via an input interface 524. The output device 512 may include a display, a printer, a transducer (e.g. a speaker, etc.), a personal digital assistant (PDA) and/or other handheld portable communication device, a combination thereof, etc. The output device 512 is interconnected to the computer 502 via an output interface 526. Some devices, such as a network adapter or a modem, can also or alternatively be used as input and/or output devices with the system 500.

The computer system 500 further includes an operating system and at least one application program. The operating system generally includes software that controls the computer system's operation and allocation of resources. The application program generally includes software that performs a task desired by the user, using computer resources made available through the operating system. In the illustrated embodiment of FIG. 5, both the operating system and the application program are shown residing within memory system 506.

In accordance with the practices of persons skilled in the art of computer programming, the present disclosure is described below with reference to symbolic representations of operations that are performed by the computer system 500. Such operations are sometimes referred to as being computer-executed. It will be appreciated that the operations which are symbolically represented include the manipulation by the CPU 504 of electrical signals representing data bits and the maintenance of data bits at memory locations in the memory system 506, as well as other processing of signals. The memory locations where data bits are maintained are physical locations that have particular electrical, magnetic, and/or optical properties corresponding to the data bits. The present disclosure can be implemented in a program or programs, comprising a series of instructions stored on a computer-readable medium. The computer-readable medium can be any of the devices, or a combination of the devices, described above (and other devices) in connection with the memory system 506. As such, methods described herein can be implemented in a computer readable medium having computer executable instructions for performing one or more of the methods, processes, and/or operations.

A system such as illustrated by way of example in FIG. 5 can be configured for facilitating a transaction for a delivery of a service by a service provider 106 to a service buyer 104. In such embodiments, a system can include a network (e.g., network 212 shown in FIG. 2, etc.) configured for transmitting electronic data, a first communication device coupled to the network and configured for receiving input from the service buyer 104. The input can include a request for a service to be provided and a description of that service to be provided. The system can further include a second communication device coupled to the network and configured for receiving a listing of a service work order and for placing a bid in response to the listed service work order. A server (such as system 500 shown in FIG. 5, etc.) can be coupled to the network. The server can be configured for performing one or more processes including receiving data relating to a service work order from the first communication device, generating a service work order in response to the received data, providing the listing with the service work order to the second communication device in an auction for bidding by one or more service providers, receiving a service provider's bid from the second communication device, and selecting a service provider from one or more service providers that submitted a bid for the service work order. The server can also be configured for transmitting to the first communication device information relating to the selected service provider and the bid associated therewith, for causing a payment from the service buyer to be escrowed, and transmitting to the second communication device data relating to the escrowed payment and the service buyer. The server can be further configured for providing an escrowed payment release authorization to the service buyer, and for allowing transfer of at least a portion of the escrowed payment to the selected service provider in response to receipt of the escrowed payment release authorization.

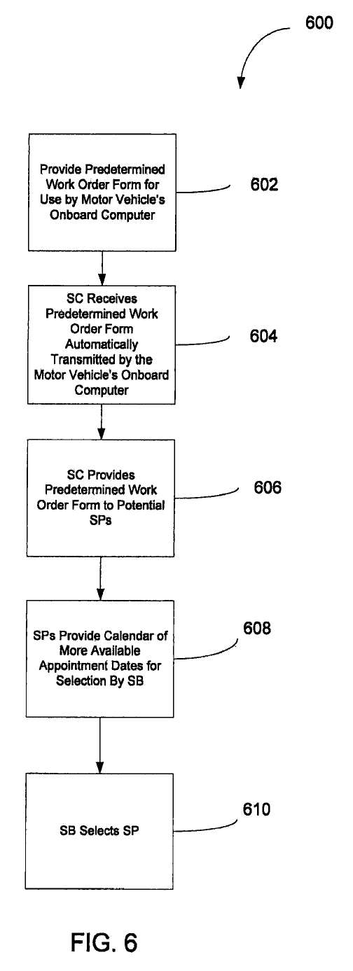

As noted earlier, various exemplary embodiments include a method in which automated data communications are received from a mobile platform or motor vehicle, such as automobile, bus, truck, motorcycle, boat, airplane, rotorcraft, watercraft, snowmobile, jet ski wave runner, bicycle, scooter, farm equipment, etc. By way of example, FIG. 6 illustrates a process flow chart of an exemplary method 600 relating to selection of a service provider for maintenance services to be performed on a motor vehicle having an onboard computer. As shown in FIG. 6, process 602 may include providing a predetermined work order form for use by the motor vehicle's onboard computer to be automatically transmitted therefrom without manual intervention by the service buyer 104 when the onboard computer has determined that the motor vehicle is in need of a maintenance service (e.g., tire rotation or oil change for an automobile, etc.). The predetermined work order form may include information identifying the service buyer 104, information identifying the motor vehicle type, and/or a description of the maintenance service to be performed on the motor vehicle. Process 604 includes the service coordinator 102 receiving the predetermined work order form automatically transmitted by the motor vehicle's onboard computer. Process 606 includes the service coordinator 102 providing the predetermined work order form to one or more potential service providers 106. At process 608, one or more service providers 106 may be allowed to provide a calendar or list of one or more available appointment dates for selection by the service buyer 104. Then at process 610, the service buyer 104 may then select a service provider 106. At which point, the method 600 may include substantially identical processes as that process 312 through 326 shown in FIG. 3 and described earlier (although this is not required for all embodiments).

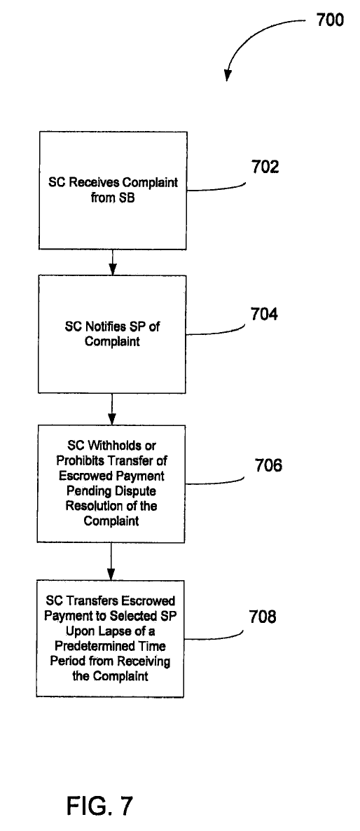

FIG. 7 illustrates a process flow chart of an exemplary dispute resolution process 700 that may be used in any one or more of the various embodiments of the present disclosure. As shown in FIG. 7, process 702 may include the service coordinator 102 receiving a complaint from a service buyer 104 with regard to the services provided by a selected service provider 106. At process 704, the service coordinator 102 may then notify the service provider 106 of the complaint. At process 706, the service coordinator 102 may withhold or prohibit transfer of the escrowed payment pending dispute resolution of the complaint. In some embodiments, process 708 may include the service coordinator 102 transferring at least a portion of the escrowed payment to the selected service provider 106 upon lapse of a predetermined time period from receiving the complaint. This dispute resolution process 700 may be used in any one or more of the various embodiments of the present disclosure. Alternatively, one or more embodiments may include other dispute resolution processes. Still further embodiments may not include any provisions or processes relating to dispute resolutions.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A method for facilitating a transaction for a delivery of a service by a service provider to a service buyer, the method comprising:
listing a service work order from a service buyer in an auction for bidding by one or more service providers;
selecting a service provider from one or more service providers that submitted a bid for the service work order listed at the auction;
causing a payment from the service buyer to be escrowed, the payment being responsive to the bid submitted by the selected service provider;
providing the selected service provider with data relating to the escrowed payment and the service buyer;
providing an escrowed payment release authorization to the service buyer; and
allowing transfer of at least a portion of the escrowed payment to the selected service provider in response to receipt of the escrowed payment release authorization.

2. The method of claim 1, further comprising receiving a registration fee from a service provider before allowing that service provider to submit a bid for the service work order listed at the auction.

3. The method of claim 1, further comprising receiving a collection fee from a service provider when payment has been escrowed.

4. The method of claim 1, further comprising validating a registration from a service provider against predefined validation criteria before allowing that service provider to submit a bid for the service work order listed at the auction, the predefined validation criteria including verification of at least one of a security bond, workers compensation, licensing, and certification.

5. The method of claim 1, further comprising receiving a registration from a service provider including at least one of a listing of a service that the service provider can provide, an identification of a service area in which the service provider can provide a service, and a description of a qualification for providing a service.

6. The method of claim 1, further comprising providing a service work order entry form for completion by the service buyer, and wherein listing the service work order in the auction includes providing a description of the service to be performed corresponding to the description provided by the service buyer in the completed service work order entry form.

7. The method of claim 6, further comprising providing at least one digital image of at least one of the service work order entry form for completion by the service buyer, or the description of the service to be performed.

8. The method of claim 1, wherein listing the service work order in the auction including categorizing the service work order to one or more predefined service categories.

9. The method of claim 1, wherein the service work order includes a minimum service provider quality rating, and wherein the selected service provider has a quality rating no less than the minimum service provider quality rating.

10. The method of claim 1, further comprising generating a rating for a service provider based upon feedback from a service buyer that received a service therefrom, and wherein the selection of a service provider includes consideration of one or more generated service provider ratings for the one or more service providers that submitted a bid.

11. The method of claim 1, further comprising:
receiving a question from a service provider about the service work order;
transmitting the question to the service buyer;
receiving a response from the service buyer; and
posting the received question and the received response in the listing of the service work order.

12. The method of claim 1, further comprising hosting a webpage allowing a service buyer to enter data relating to a service work order to be listed in an auction for bidding by one or more service providers.

13. The method of claim 1, further comprising hosting a webpage on which the service work order can be listed in an online auction and through which bids can be submitted by service providers.

14. The method of claim 1, wherein the escrowed payment release authorization includes at least one or more of an alphanumeric code, a numeric code, an alphabetic code, a voice authorization code, a voice recognition authentication, a barcode, a password, and a fingerprint authentication.

15. The method of claim 1, further comprising notifying the selected service provider of a complaint from the service buyer in regard to the provided service.

16. The method of claim 15, wherein transfer of the escrowed payment is not allowed at least until after the lapse of a predetermined time period from receipt of the complaint.

17. The method of claim 1, further comprising providing to a financing party a request from the service buyer for financing for at least a portion of the payment to be escrowed, and wherein causing a payment from service provider to be escrowed includes causing a payment provided by the financing party to be escrowed.

18. The method of claim 1, wherein the service work order includes a schedule of payments for one or more services, and wherein the escrowed payment release authorization and allowing transfer of at least a portion of the escrowed payment are based at least partially on the schedule of payments.

19. The method of claim 1, further comprising causing a supplemental payment from the service buyer to be escrowed, the supplemental payment corresponding to an incremental cost associated with a service work order change request.

20. The method of claim 19, wherein the service work order change request is provided by the service provider or service buyer.

21. The method of claim 20, further comprising providing the selected service provider with a notification of the escrowed supplemental payment, and wherein allowing transfer of at least a portion of the escrowed payment to the selected service provider includes allowing transfer of at least a portion of escrowed supplemental payment to the selected service provider.

22. The method of claim 1, wherein the escrowed payment is allowed to be transferred to the service provider only after the escrowed payment release authorization is provided in a communication from at least one of the service providers or the service buyer.

23. The method of claim 22, wherein the communication includes a data communication having the escrowed payment release authorization.

24. The method of claim 1, wherein allowing the transfer of at least a portion of the escrowed payment includes at least one of electronically transferring payment to an account of the service provider, electronically issuing a credit to an account of the service provider, and issuing a payment to the service provider.

25. The method of claim 1, further comprising, prior to selecting the service provider that will provide the service for completion of the service work order:
selecting two or more preliminary service providers from the service providers that submitted bids for the service work order listed at the auction;
providing to the service buyer information relating to the selected two or more preliminary service providers;
receiving feedback from the service buyer in response to the provided information;
wherein the service provider that will provide the service for completion of the service work is selected from the two or more preliminary service providers, with the selection being based at least partially on the feedback from the service buyer.

26. The method of claim 1, wherein the service work order includes a plurality of sub-service work orders associated with different types of service work to be performed, and wherein the method includes for each sub-service work order:
listing each sub-service work order in an auction for bidding by one or more service providers;
selecting a service provider for each sub-service work order from one or more service providers that submitted a bid for the sub-service work order listed at the auction;
causing a payment from the service buyer to be escrowed, the payment being responsive to the bid submitted by the selected service provider for the corresponding sub-service work order;
providing the selected service provider for each sub-service work order with data relating to the escrowed payment and the service buyer;
providing an escrowed payment release authorization to the service buyer for each sub-service work order; and
allowing transfer of at least a portion of the escrowed payment for the corresponding sub-service work order to the selected service provider in response to receipt of the escrowed payment release authorization.

27. The method of claim 1, wherein the service work order relates to a service including at least one of remodeling a building, constructing a building addition, and constructing a new building.

28. The method of claim 1, wherein the service work order relates to a service including at least one of an automotive service, a heating service, a plumbing service, a flooring service, a professional service, a heating/air conditioning service, a garage door service, a glass service, a landscaping service, a building service, an electrical service, a painting service, a telecommunication service, a computer service, an appliance service, a cleaning service, and any business or service for which has been assigned a Standard Industrial Classification (SIC) code.

29. The method of claim 1, further comprising receiving an automated data communication generated by a computer onboard a mobile platform identifying the service buyer, a type of mobile platform, and the service work order including a description of a maintenance service to be performed on the mobile platform.

30. The method of claim 29, further comprising allowing the service provider to provide a calendar of one or more available appointment dates for selection by the service buyer.

31. The method of claim 29, further comprising providing a predetermined work order form for use by a computer onboard a motor vehicle such that the onboard computer causes the predetermined work order form to be automatically transmitted when the onboard computer determines that the motor vehicle needs maintenance service, and providing the predetermined work order form to one or more potential service providers.

32. The method of claim 1, further comprising receiving an automated data communication generated by a computer of a appliance identifying the service buyer, a type of appliance, and the service work order including a description of a maintenance service to be performed on the appliance.

33. A method for facilitating a transaction for a delivery of a service by a service provider to a service buyer, the method comprising:
hosting a first webpage configured for providing a service work order entry form for completion by a service buyer;
hosting a second webpage configured for online auctions of service work orders;
listing on the second webpage a service work order in an online auction for bidding by one or more service providers, the listing corresponding to data entered by a service buyer into a service work order entry form provided by the first webpage;
selecting a service provider from one or more service providers that submitted a bid, via the second webpage, for the service work order listed at the online auction;
causing a payment from the service buyer to be escrowed, the payment being responsive to the bid submitted by the selected service provider;
electronically communicating the selected service provider with data relating to the escrowed payment and the service buyer;
electronically communicating an escrowed payment release authorization to the service buyer; and
electronically transferring at least a portion of the escrowed payment to the selected service provider in response to receipt of the escrowed payment release authorization.

34. A system for facilitating a transaction for a delivery of a service by a service provider to a service buyer, the system comprising:
a network configured for transmitting electronic data;
a first communication device coupled to the network and configured for allowing a service buyer to enter data for a service work order;
a second communication device coupled to the network and configured for receiving a listing of a service work order and for placing a bid in response to the listed service work order; and
a server coupled to the network and configured for:
receiving data relating to a service work order from the first communication device;
generating a service work order in response to the received data;
providing the listing with the service work order to the second communication device in an auction for bidding by one or more service providers;
receiving a service provider's bid from the second communication device;
selecting a service provider from one or more service providers that submitted a bid for the service work order;
transmitting to the first communication device information relating to the selected service provider and the bid associated therewith;
causing a payment from the service buyer to be escrowed;
transmitting to the second communication device data relating to the escrowed payment and the service buyer;
providing an escrowed payment release authorization to the service buyer; and
allowing transfer of at least a portion of the escrowed payment to the selected service provider in response to receipt of the escrowed payment release authorization.

35. A method relating to selection of a service provider for maintenance services to be performed on a motor vehicle having an onboard computer, the method comprising:
providing a predetermined work order form for use by the motor vehicle's onboard computer to be automatically transmitted therefrom without manual intervention by the service buyer when the onboard computer has determined that the motor vehicle needs a maintenance service, the predetermined work order form including information identifying the service buyer, information identifying the motor vehicle type, and a description of the maintenance service to be performed on the motor vehicle;
receiving the predetermined work order form automatically transmitted by the motor vehicle's onboard computer; and
providing the predetermined work order form to one or more potential service providers.

36. The method of claim 35, further comprising:
selecting a service provider from the one or more potential service providers that submitted a bid to perform the maintenance service for the motor vehicle;
causing a payment from the service buyer to be escrowed, the payment being responsive to the bid submitted by the selected service provider;
providing the selected service provider with data relating to the escrowed payment and the service buyer;
providing an escrowed payment release authorization to the service buyer; and
allowing transfer of at least a portion of the escrowed payment to the selected service provider in response to receipt of the escrowed payment release authorization.

37. The method of claim 35, further comprising allowing a service provider to provide to the service buyer a calendar of one or more available appointment dates for performing the maintenance service for the motor vehicle.
